(19) United States
(12) Patent Application Publication
(10) Pub. No.: US 2023/0421976 A1
(43) Pub. Date: Dec. 28, 2023

(54) AC POLARIZATION CIRCUIT OF CAPACITIVE SENSOR

(71) Applicants: Jun Li, Yichun (CN); Shenzhen Ningrui Electronical Technology Co., Ltd., Shenzhen (CN)

(72) Inventor: Jun Li, Yichun (CN)

(21) Appl. No.: 18/463,353

(22) Filed: Sep. 8, 2023

(30) Foreign Application Priority Data
Mar. 24, 2023 (CN) 202310300566.5
Mar. 24, 2023 (CN) 202320614700.4

(51) Int. Cl. H04R 29/00; H04R 19/04

(52) U.S. Cl. CPC H04R 29/004; H04R 19/04; H04R 2410/03

(57) ABSTRACT

The present invention discloses an AC polarization circuit of a capacitive sensor, comprising: an AC signal generator, a transducer, a detection circuit, a pickup capacitor C2 and a carrier eliminating capacitor C1. The output end of the AC signal generator is connected with a primary side of the transducer; an intermediate node of a secondary side of the transducer is grounded; one end of the secondary side is connected with one end of the pickup capacitor C2, and the other end of the secondary side is connected with one end of the carrier eliminating capacitor C1; and the other end of the pickup capacitor C2 and the other end of the carrier eliminating capacitor C1 are connected with the detection circuit. The present invention reduces the output impedance of a pickup head by pushing a pickup signal to high frequency through AC polarization.

### TECHNICAL FIELD

The present invention relates to the technical field of capacitive sensors, and more particularly relates to an AC polarization circuit of a capacitive sensor.

### BACKGROUND

The capacitive sensor is widely used for many advantages of high sensitivity and wide frequency response range. It can be seen in professional field and civilian field. A capacitive microphone uses the capacitive sensor as a pickup component of sound.

Although the capacitive sensor is very mature, it has some drawbacks. Noise is one of the drawbacks. The unreasonable pickup principle of the capacitive sensor is the main reason for the low signal-to-noise ratio of the capacitive microphone.

Therefore, how to provide an AC polarization circuit of a capacitive microphone with high signal-to-noise ratio is a problem to be urgently solved by those skilled in the art.

### SUMMARY

In view of this, the present invention provides an AC polarization circuit of a capacitive sensor, which can greatly improve the signal-to-noise ratio of a capacitive microphone.

To achieve the above purpose, the present invention adopts the following technical solution:

An AC polarization circuit of a capacitive sensor comprises: an AC signal generator, a transducer, a detection circuit, a pickup capacitor C2 and a carrier eliminating capacitor C1, wherein the output end of the AC signal generator is connected with a primary side of the transducer; an intermediate node of a secondary side of the transducer is grounded; one end of the secondary side is connected with one end of the pickup capacitor C2, and the other end of the secondary side is connected with one end of the carrier eliminating capacitor C1; and the other end of the pickup capacitor C2 and the other end of the carrier eliminating capacitor C1 are connected with the detection circuit.

Preferably, the AC polarization circuit further comprises a resonant inductor L1, and connection nodes of the pickup capacitor C2, the carrier eliminating capacitor C1 and the detection circuit are grounded through the resonant inductor L1.

Preferably, the detection circuit comprises a detection diode D1, a resistor R4 and a resistor R3, and the other end of the pickup capacitor C2 and the other end of the carrier eliminating capacitor C1 are connected with a positive electrode of the detection diode D1; a negative electrode of the detection diode D1 is connected with the resistor R4; and a connection node of the detection diode D1 and the resistor R4 is grounded through the resistor R3.

It can be known from the above technical solutions that compared with the prior art, the present invention provides an AC polarization circuit of a capacitive sensor, which reduces the output impedance of a pickup head by pushing a pickup signal to high frequency through AC polarization, so as to achieve the purpose of improving a signal-to-noise ratio.

### DESCRIPTION OF DRAWINGS

To more clearly describe the technical solution in the embodiments of the present invention or in the prior art, the drawings required to be used in the description of the embodiments or the prior art will be simply presented below. Apparently, the drawings in the following description are merely the embodiments of the present invention, and for those ordinary skilled in the art, other drawings can also be obtained according to the provided drawings without contributing creative labor.

FIG. 1 is a schematic block diagram of an AC polarization circuit of a capacitive sensor provided by the present invention.

FIG. 2 is a diagram of an application example of an AC polarization circuit of a capacitive sensor provided by the present invention.

### DETAILED DESCRIPTION

The technical solution in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

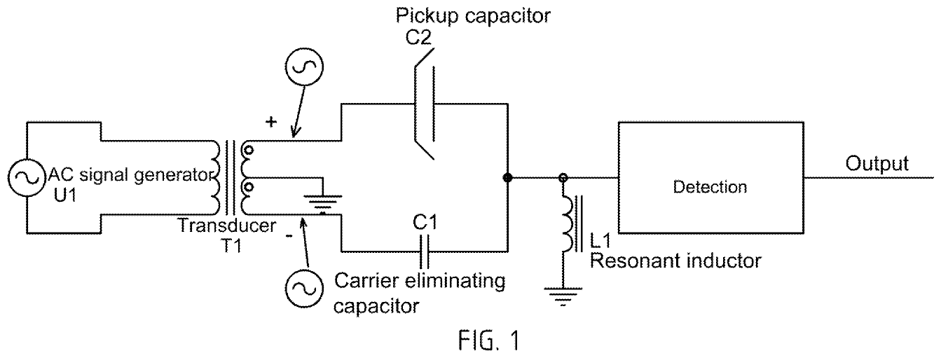

Embodiments of the present invention disclose an AC polarization circuit of a capacitive sensor, as shown in FIG. 1, comprising: an AC signal generator, a transducer, a detection circuit, a pickup capacitor C2 and a carrier eliminating capacitor C1. The output end of the AC signal generator is connected with a primary side of the transducer; an intermediate node of a secondary side of the transducer is grounded; one end of the secondary side is connected with one end of the pickup capacitor C2, and the other end of the secondary side is connected with one end of the carrier eliminating capacitor C1; and the other end of the pickup capacitor C2 and the other end of the carrier eliminating capacitor C1 are connected with the detection circuit.

In the above embodiment, the AC signal generator is used for generating a high-frequency AC signal, and the transducer is used for generating two high-frequency signals with the same frequency and opposite polarity. According to the relationship between capacitive reactance and frequency of the capacitor, when the frequency is higher, the capacitive reactance of the capacitor is lower. A sound signal on the pickup head is directly modulated at a high frequency, which greatly reduces the output impedance of the modulated signal. That is, the output impedance of the pickup capacitor C2 is reduced, and the signal amplitude inputted to the detection circuit is increased, thereby improving the signal-to-noise ratio of the capacitive microphone.

In the present embodiment, the AC polarization circuit further comprises a resonant inductor L1, and connection nodes of the pickup capacitor C2, the carrier eliminating capacitor C1 and the detection circuit are grounded through the resonant inductor L1.

In the above embodiment, the high-frequency AC signal (usually sine wave) generated by the AC signal generator U1 is first sent to a transducer T1 to generate two high-frequency signals with the same frequency and opposite polarity. Then, one signal is sent to one end of the pickup capacitor C2 of the microphone and the other signal is sent to one end of the carrier eliminating capacitor C1. A microphone induction capacitor C2 and the other end of the carrier eliminating capacitor C1 are connected together and then connected with the resonant inductor L1, and the other end of L1 is grounded. The microphone induction capacitor C2, the carrier eliminating capacitor C1 and the resonant inductor L1 form a resonant network. The resonant network plays a role of “amplification” for the signal, so as to improve the sensitivity of an AM signal and directly improve the signal amplitude after the detector.

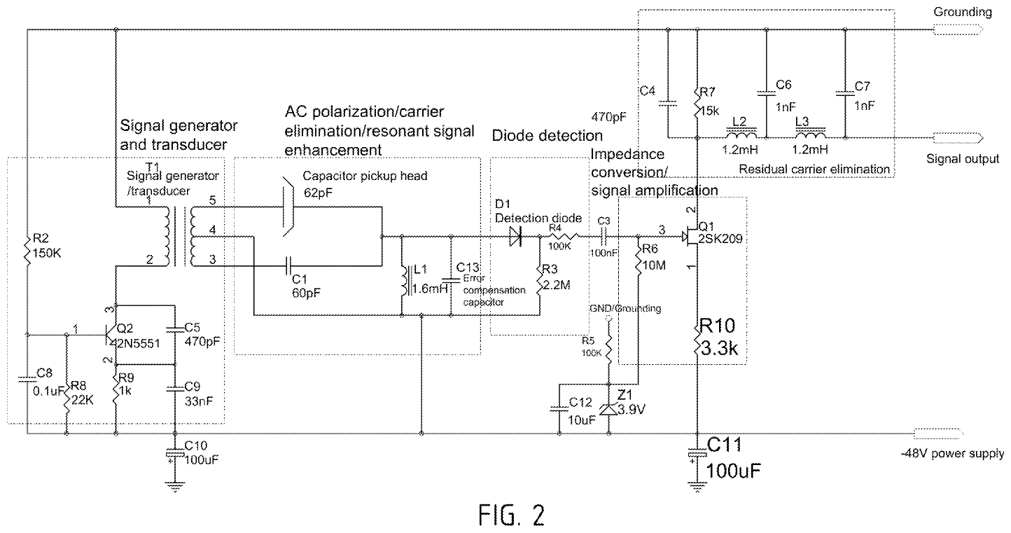

In the present embodiment, as shown in FIG. 2, the detection circuit comprises a detection diode D1, a resistor R4 and a resistor R3, and the other end of the pickup capacitor C2 and the other end of the carrier eliminating capacitor C1 are connected with a positive electrode of the detection diode D1; a negative electrode of the detection diode D1 is connected with the resistor R4; and a connection node of the detection diode D1 and the resistor R4 is grounded through the resistor R3.

Specifically, the AC signal generator and the transducer are integrated together. The intermediate node of the secondary side of the transducer is grounded, and one end of the secondary side is connected with one end of the pickup capacitor C2; and the other end of the secondary side is connected with one end of the carrier eliminating capacitor C1. Two capacitor outputs are superimposed and then connected with the resonant inductor L1. C13 finely adjusts the resonant frequency to ensure adequate sensitivity. The signal after resonant amplification is sent to the detection diode D1, and the output of the detection diode D1 is sent to an MOS tube Q1 after passing through a DC blocking capacitor C3 for impedance conversion and amplification. Finally, the residual carrier signal is filtered through an LC network. The whole pickup process of the capacitive microphone is also a process of modulation and demodulation of the AM signal.

Each embodiment in the description is described in a progressive way. The difference of each embodiment from each other is the focus of explanation. The same and similar parts among all of the embodiments can be referred to each other. For a device disclosed by the embodiments, because the device corresponds to a method disclosed by the embodiments, the device is simply described. Refer to the description of the method part for the related part.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

What is claimed is:

1. An AC polarization circuit of a capacitive sensor, comprising: an AC signal generator, a transducer, a detection circuit, a pickup capacitor C2 and a carrier eliminating capacitor C1, wherein the output end of the AC signal generator is connected with a primary side of the transducer; an intermediate node of a secondary side of the transducer is grounded; one end of the secondary side is connected with one end of the pickup capacitor C2, and the other end of the secondary side is connected with one end of the carrier eliminating capacitor C1; and the other end of the pickup capacitor C2 and the other end of the carrier eliminating capacitor C1 are connected with the detection circuit.

2. The AC polarization circuit of the capacitive sensor according to claim 1, further comprising a resonant inductor L1, wherein connection nodes of the pickup capacitor C2, the carrier eliminating capacitor C1 and the detection circuit are grounded through the resonant inductor L1.

3. The AC polarization circuit of the capacitive sensor according to claim 1, wherein the detection circuit comprises a detection diode D1, a resistor R4 and a resistor R3, and the other end of the pickup capacitor C2 and the other end of the carrier eliminating capacitor C1 are connected with a positive electrode of the detection diode D1; a negative electrode of the detection diode D1 is connected with the resistor R4; and a connection node of the detection diode D1 and the resistor R4 is grounded through the resistor R3.

4. The AC polarization circuit of the capacitive sensor according to claim 2, wherein the detection circuit comprises a detection diode D1, a resistor R4 and a resistor R3, and the other end of the pickup capacitor C2 and the other end of the carrier eliminating capacitor C1 are connected with a positive electrode of the detection diode D1; a negative electrode of the detection diode D1 is connected with the resistor R4; and a connection node of the detection diode D1 and the resistor R4 is grounded through the resistor R3.
